(19) United States
(12) Patent Application Publication
(10) Pub. No.: US 2016/0016099 A1
(43) Pub. Date: Jan. 21, 2016

(54) FILTER CARTRIDGE HAVING DOUBLE THREADS

(71) Applicants: Chingshiung Lin, Pingtung City (TW); Kemflo (Nanjing) Environmental Technology Co., Ltd, Nanjing (CN); Kemflo International Co., Ltd., Da Zhou (TW)

(72) Inventors: Jack Lin, Nanjing (CN); Yucui Qian, Nanjing (CN); Peng Chen, Nanjing (CN)

(73) Assignees: Kemflo (Nanjing) Environmental Technology Co., Ltd, Nanjing (CN); Kemflo International Co., Ltd., Da Zhou (TW); Chingshiung Lin, Pingtung City (TW)

(21) Appl. No.: 14/749,649

(22) Filed: Jun. 25, 2015

(30) Foreign Application Priority Data
Jun. 25, 2014 (CN) 201420341364.1

(51) Int. Cl. B01D 27/10; B01D 35/30; B01D 29/13

(52) U.S. Cl. CPC B01D 27/101; B01D 29/13; B01D 35/306

(57) ABSTRACT

A filter cartridge having double threads is provided, and has a housing and a cap. The housing is opaque and provided with a connecting portion, a filter containing portion and a bottom portion. The housing and the cap are tightly connected to each other by a connector. When the housing and the cap are assembled via the connector, various types of threads and shapes of the bottom portion of the housing can be selected. Additionally, users can conveniently observe the using condition of a filter media through an opened window formed on an outer circumference surface of the bottom portion of the housing and a transparent base, so that the user can then directly decide whether the filter media should be changed or not.

### FIELD OF THE INVENTION

The disclosure relates to a component of a water filter device, and more particularly to a filter cartridge having double threads.

### BACKGROUND OF THE INVENTION

With the improvement of the quality of life, people are paying more attention to drinking water safety, so that water filter products are widely used in daily life. Usually, a filter media is installed into a filter cartridge to form a filter component, and different filter components are connected to form a filter device.

Since different filter media have different use periods, users should change the filter media before the use period thereof is out, otherwise the water quality will be influenced, becoming secondary pollution. During actual use, due to many factors, the real use period of the filter media is different from the use period marked by the manufacturer, wherein the most import factor which influences the real use period of the filter media is the actual water quality. Whether the filter media should be changed or not is directly dependent upon the using conditions of the filter media. However, since the filter media is installed in the filter cartridge, and it cannot be taken out from the filter cartridge during use, a user cannot directly observe the using condition of the filter media.

The market now provides two kinds of filter cartridge, opaque and fully transparent. Using a transparent filter cartridge, users can easily observe the using condition of the filter media, but the transparent filter cartridge is rarely used because the pressure resistance thereof is bad. The other hand, the opaque filter cartridge cannot meet the need of observing the filter media.

Therefore, users need a new kind of filter media to solve the above-mentioned problem.

### SUMMARY OF THE INVENTION

An objective of the disclosure is to provide a filter cartridge having double threads; wherein the connecting mode between a housing and a cap and the shape of the bottom portion of the housing are re-designed, so that the filter cartridge of the present invention not only has the observable effect of the conventional transparent filter cartridge, but it also can overcome the problem that the pressure resistance of the conventional filter cartridge is not good enough.

For accomplishing the above-mentioned objective, the disclosure provides a filter cartridge having double threads, which comprises a housing and a cap; wherein the housing is provided with a connecting portion, a filter containing portion, and a bottom portion; and the housing and the cap are tightly connected to each other by a connector; wherein an outer circumference surface of the connector is provided with an outer connector thread, and an inner circumference surface of the connector is provided with an inner connector thread; the connecting portion of the housing has a first thread screw-connected to one of the outer connector thread and the inner connector thread of the connector; and the cap has a second thread screw-connected to the other of the outer connector thread and the inner connector thread of the connector.

In one embodiment according to the present invention, the diameter of the connecting portion is greater than the diameter of the filter containing portion, so that a junction between the connecting portion and the filter containing portion is formed with an inner step portion. Additionally, an inner bottom of the connector is provided with a first ring installing groove, and a first O ring is installed in the first ring installing groove. That is, in the embodiment, the connecting portion of the housing is tightly engaged with the connector by the first internal-thread of the housing being screw-connected with the outer connector thread, and the cap is tightly engaged with the connector by that the first external-thread of the cap being screw-connected with the inner connector thread.

In one embodiment according to the present invention, the diameter of the connecting portion is smaller than the diameter of the filter containing portion, so that a junction between the connecting portion and the filter containing portion is formed with an outer step portion. Additionally, a top of the connecting portion of the housing is provided with a second ring installing groove, and a second O ring is installed in the second ring installing groove. That is, in the embodiment, the connecting portion of the housing is tightly engaged with the connector by the second external-thread of the housing being screw-connected with the inner connector thread, and the cap is tightly engaged with the connector by the second internal-thread of the cap being screw-connected with the outer connector thread.

In one embodiment according to the present invention, the filter cartridge further comprises a transparent base; the transparent base is installed inside the bottom portion of the housing; the transparent base is tightly matched with the inner bottom of the housing; and an outer circumference surface of the bottom portion of the housing is provided with at least one opened window. Preferably, the outer circumference surface of an upper edge of the transparent base is provided with a fourth ring installing groove, and a fourth O ring is installed in the fourth ring installing groove.

In one embodiment according to the present invention, one or both of the inner connector thread and the outer connector thread are interrupted threads. Preferably, the outer connector thread is an interrupted rectangular thread, and the inner connector thread is an interrupted trapezoidal thread.

In one embodiment according to the present invention, a center of the bottom portion of the housing is projected toward the connecting portion of the housing, so that the bottom portion is concave inward the housing.

Certainly, there are other common components of the conventional filter cartridge, such as a water intake and a water outlet installed on the cap. Since the cap is similar to a conventional cap, the cap of the present invention is not described in detail hereinafter.

In the present invention, when the housing and the cap are assembled via the connector, various types of the threads and shapes of the bottom portion of the housing can be selected. Thus, a better pressure resistance of the filter cartridge can be obtained, and the manufacturing cost thereof will not be increased. Additionally, users can conveniently observe the using condition of the filter media through an opened window formed on an outer circumference surface of the bottom portion of the housing and a transparent base, so that the user then can decide whether the filter media should be changed or not.

The filter cartridge of the present invention not only has the observable effect of a conventional transparent filter cartridge, but also it can overcome the problem that the pressure resistance of the conventional filter cartridge is not good enough.

### DESCRIPTION OF THE DRAWINGS

FIG. 1 is a perspective view of a filter cartridge according to a first embodiment of the present invention;

FIG. 2 is an exploded view of the filter cartridge of FIG. 1;

FIG. 3 is a cross-sectional view of the filter cartridge of FIG. 1;

FIG. 4 is a perspective view of a filter cartridge according to a second embodiment of the present invention;

FIG. 5 is an exploded view of the filter cartridge of FIG. 4;

FIG. 6 is a cross-sectional view of the filter cartridge of FIG. 4; and

FIG. 7 is a perspective view of a filter cartridge according to a third embodiment of the present invention.

### DETAILED DESCRIPTION OF THE PREFERRED EMBODIMENTS

The foregoing objects, features, and advantages adopted by the present invention can be best understood by referring to the following detailed description of the preferred embodiments and the accompanying drawings. Furthermore, the directional terms described in the present invention, such as upper, lower, front, rear, left, right, inner, outer, side, etc., are only directions with reference to the accompanying drawings, so that the used directional terms are used to describe and understand the present invention, but the present invention is not limited thereto. In the drawings, units with similar structures use the same numerals.

### First Embodiment

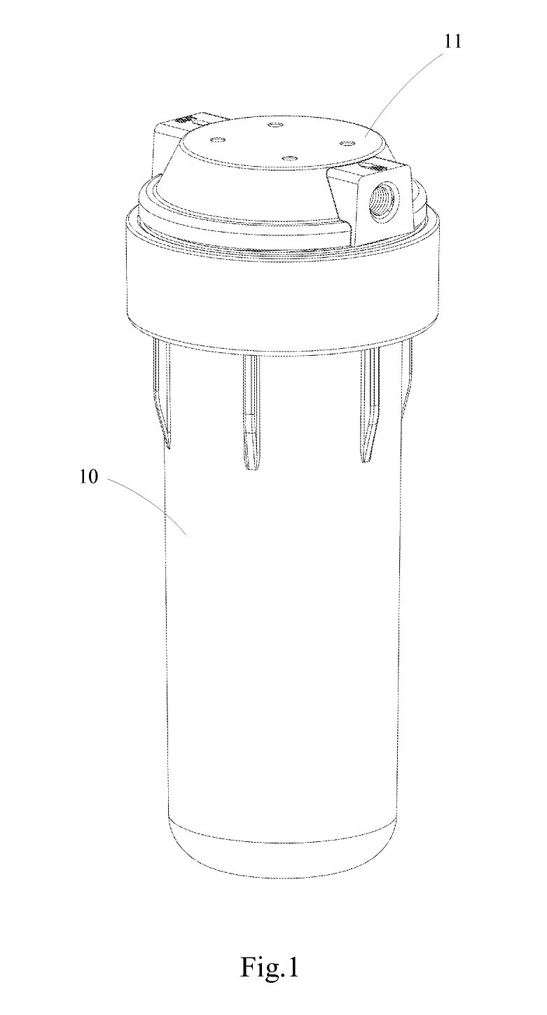

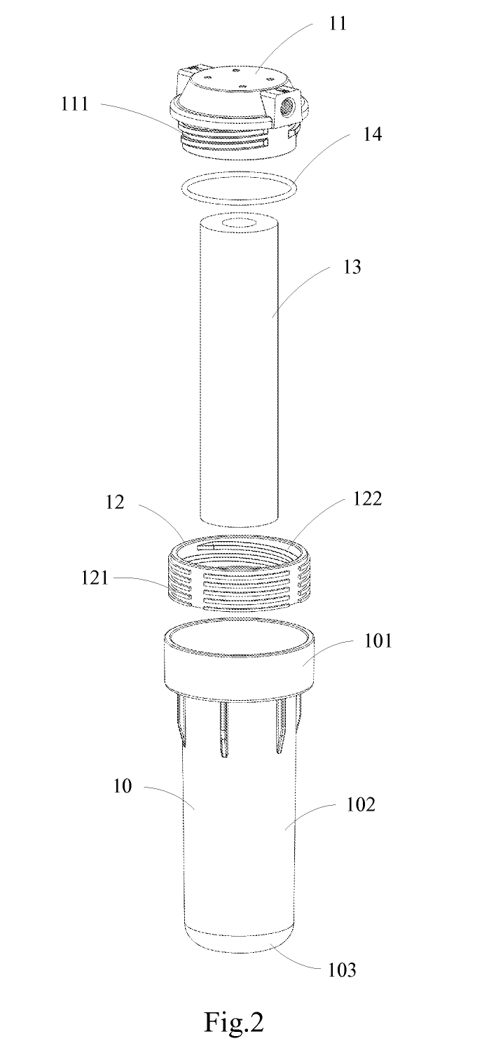

Refer now to FIGS. 1 and 2, this embodiment provides a filter cartridge, which comprises a housing 10 and a cap 11, wherein the housing 10 and the cap 11 are fastened to each other by a connector 12.

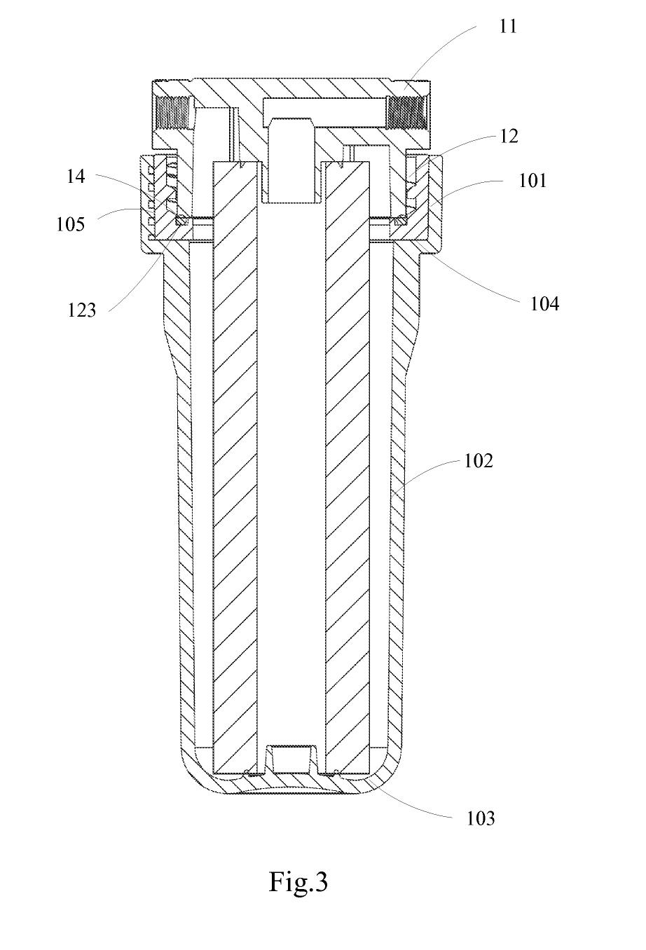

Refer now to FIGS. 2 and 3, the housing 10 comprises a connecting portion 101, a filter containing portion 102, and a bottom portion 103. The diameter of the connecting portion 101 is slightly greater than the diameter of the filter containing portion 102, so that a junction between the connecting portion 101 and the filter containing portion 102 is formed with an inner step portion 104. As shown in FIG. 3, the center of the bottom portion 103 of the housing 10 is projected toward the connecting portion 101 of the housing 10, so that the bottom portion 103 is concave inward the housing. Therefore, the design of the bottom portion 103 can make the filter cartridge have more pressure resistance.

As shown in FIG. 3, an inner bottom of the connector 12 is provided with a first ring installing groove 123, and a first O ring 14 is installed in the first ring installing groove 123.

Refer to FIGS. 2 and 3, the outer circumference surface of the connector 12 is provided with an outer connector thread 121, and the inner circumference surface of the connector 12 is provided with an inner connector thread 122. For engaging with the connector 12, an inner circumference surface of the connecting portion 101 of the housing 10 is correspondingly provided with a first internal-thread 105 screw-connected with the outer connector thread 121, and an outer circumference surface of the lower portion of the cap 11 is correspondingly provided with a first external-thread 111 screw-connected with the inner connector thread 122. That is, in the embodiment, the connecting portion 101 of the housing 10 is tightly engaged with the connector 12 by the first internal-thread 105 of the housing 10 being screw-connected with the outer connector thread 121, and the cap 11 is tightly engaged with the connector 12 by the first external-thread 111 of the cap 11 being screw-connected with the inner connector thread 122.

Furthermore, as shown in FIGS. 2 and 3, the first internal-thread 105 and the outer connector thread 121 are interrupted rectangular threads, and the first external-thread 111 and the inner connector thread 122 are interrupted trapezoidal threads.

Certainly, there are common components, such as a water intake and a water outlet, installed on the cap 11. Since the cap 11 is similar to a conventional cap, it is not described in detail.

When using the filter cartridge, as shown in FIG. 3, the outer connector thread 121 of the connector 12 is screw-connected with the first internal-thread 105 of the housing 10, and the bottom of the connector 12 is pressed against the inner step portion 104, so as to fix the connector 12 into the connecting portion 101 of the housing 10. After inserting a filter media 13, the first external-thread 111 of the cap 11 is screw-connected with the inner connector thread 122 of the connector 12. Meanwhile, the bottom of the cap 11 is pressed onto the first O ring 14, which is installed in the first ring installing groove 123, so as to connect and seal the cap 11 and the connector 12.

### Second Embodiment

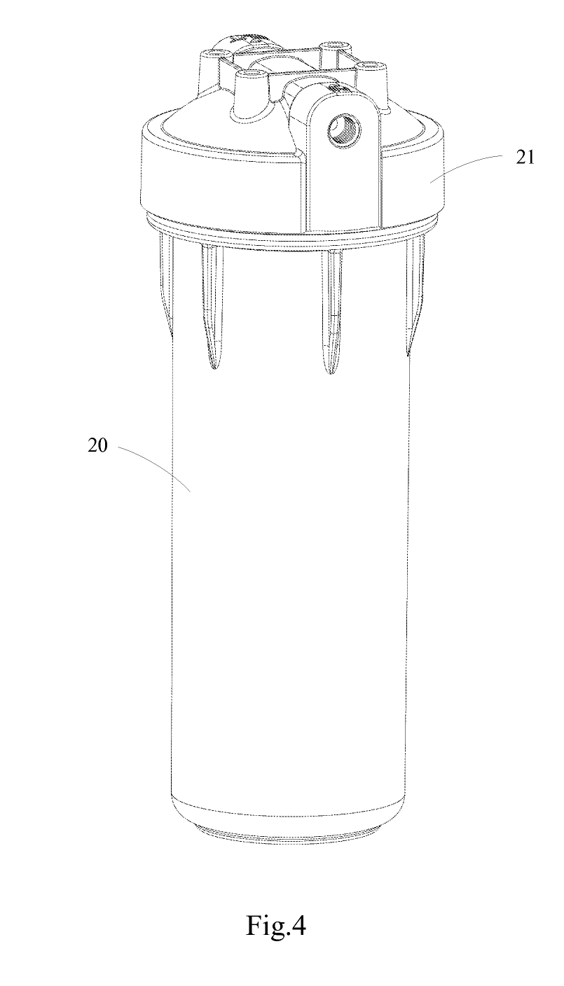

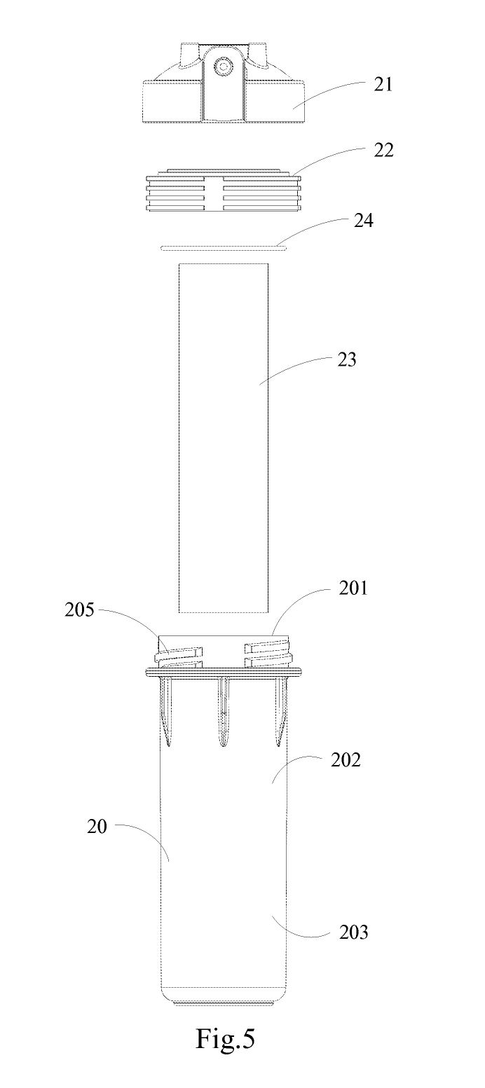

Refer now to FIGS. 4 and 5, this embodiment provides another filter cartridge, which comprises a housing 20 and a cap 21, wherein the housing 20 and the cap 21 are fastened to each other by a connector 22.

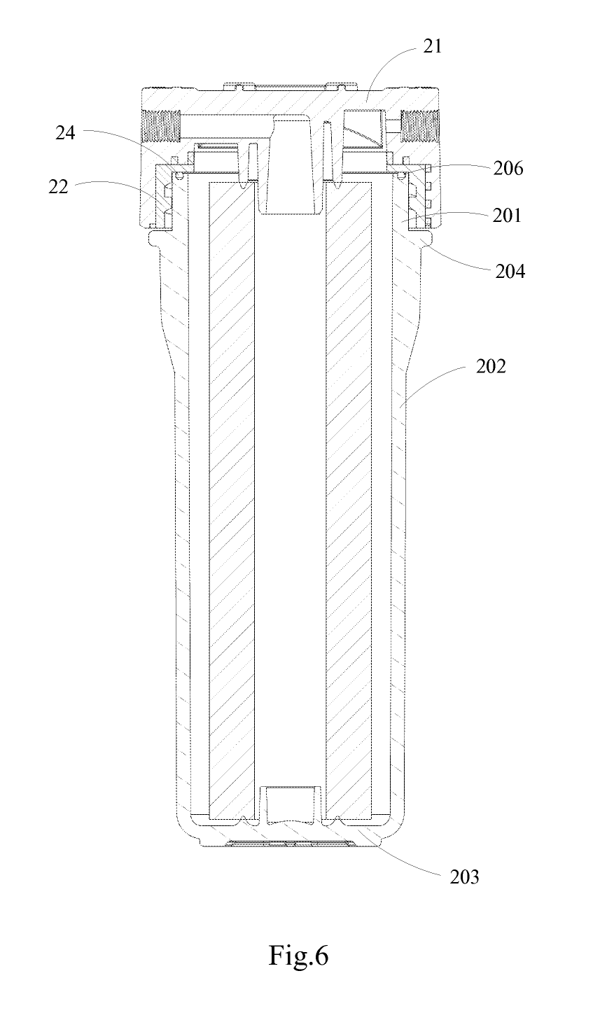

Refer now to FIGS. 5 and 6, the housing 20 comprises a connecting portion 201, a filter containing portion 202, and a bottom portion 203. The diameter of the connecting portion 201 is slightly smaller than the diameter of the filter containing portion 202, so that a junction between the connecting portion 201 and the filter containing portion 202 is formed with an outer step portion 204. As shown in FIG. 6, the center of the bottom portion 203 of the housing 20 is projected toward the connecting portion 201 of the housing 20, so that the bottom portion 203 is concave inward the housing. Therefore, the design of the bottom portion 203 can make the filter cartridge have more pressure resistance.

As shown in FIG. 6, a top of the connecting portion 201 of the housing 20 is provided with a second ring installing groove 206, and a second O ring 24 is installed in the second ring installing groove 206.

In this embodiment, the connector 22 is similar to the connector 12 of the first embodiment, but the differences are that: as shown in FIGS. 5 and 6, for respectively engaging with the connector 22, the outer circumference surface of the connecting portion 201 of the housing 20 is provided with a second external-thread 205 which is screw-connected with the inner connector thread, and the inner circumference surface of the lower portion of the cap 21 is provided with a second internal-thread (not shown) which is screw-connected with the outer connector thread. That is, as shown in FIG. 6, in the embodiment, the connecting portion 201 of the housing 20 is tightly engaged with the connector 22 by the second external-thread 205 of the housing 20 being screw-connected with the inner connector thread, and the cap 21 is tightly engaged with the connector 22 by the second internal-thread (not shown) of the cap 21 being screw-connected with the outer connector thread.

Certainly, there are common components, such as a water intake and a water outlet, installed on the cap 21. Since the cap 21 is similar to a conventional cap, it does not be described in detail.

When using the filter cartridge, as shown in FIG. 6, a filter media 23 is inserted, and the inner connector thread of the connector 22 is screw-connected with the second external-thread 205 of the housing 20, and the bottom of the connector 22 is pressed against the outer step portion 204, so as to fix the connector 22 into the connecting portion 201 of the housing 20. The connector 22 contacts the top of the housing 20, and the connector 22 is pressed on the second O ring 24, which is installed in the second ring installing groove 206, so as to connect and seal the cap 21 and the connector 22. Next, the cap 21 is connected with the connector 22 by the second internal-thread (not shown) of the cap 21 being screw-connected with the outer connector thread, so as to fasten and connect the cap 21 and the housing 20.

### Third Embodiment

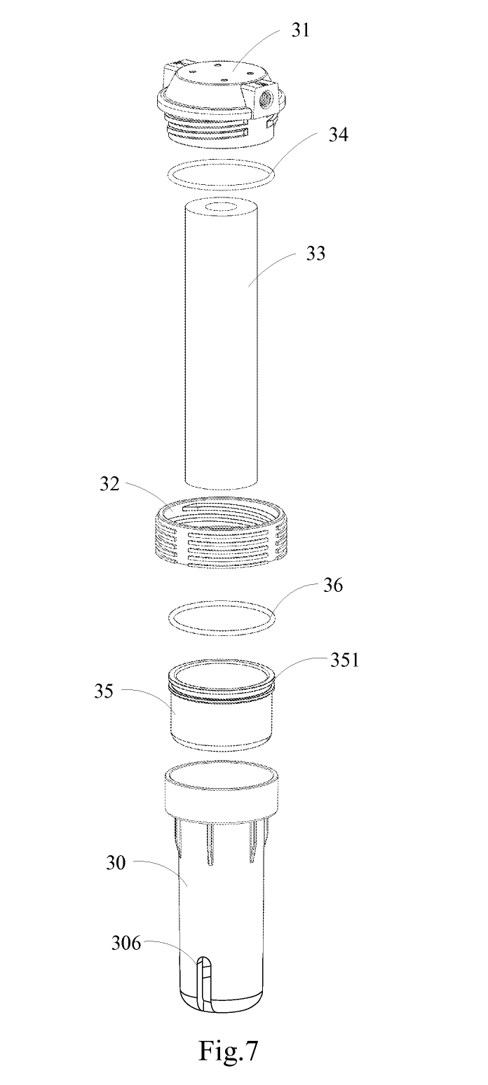

Refer to FIG. 7, this embodiment provides another filter cartridge 30, which is based on the filter cartridge of the first or second embodiment, and further added visible windows. Therefore, in this embodiment, the filter cartridge 10 of the first embodiment is improved, but it is easily understood that the filter cartridge 20 of the second embodiment can be improved in the same way.

As shown in FIG. 7, the filter cartridge 30 of the embodiment comprises a housing 30, a cap 31, a connector 32, and a transparent base 35, wherein the housing 30 and the cap 31 are fastened and connected by the connector 32; and the transparent base 35 is installed inside a bottom portion of the housing 30, and the transparent base 35 is tightly matched with the inner bottom of the housing 30. The same as in the first embodiment, the inner bottom of the connector 32 is provided with a third ring installing groove (not shown), and a third O ring 34 is installed in the third ring installing groove. Since the corresponding positions and connection methods are the same as the first embodiment, they do not be described again here.

As shown in FIG. 7, the outer circumference surface of an upper edge of the transparent base 35 is provided with a fourth ring installing groove 351, and a fourth O ring 36 is installed in the fourth ring installing groove 351. Additionally, an outer circumference surface of the bottom portion of the housing 30 is provided with at least one opened window 306. Preferably, the window 306 can be symmetrical two or four windows.

When using the filter cartridge, the transparent base 35 is firstly installed on the bottom of the housing 30, and the outer circumference of the fourth O ring 36 is pressed against the inner circumference surface of the housing 30, so that the transparent base 35 can be sealed and fixed on the bottom of the housing 30, and prevent the transparent base 35 from being moved when under pressure when in operation. After inserting a filter media 33 into the transparent base 35, the cap 31 is connected and sealed with the housing 30 by the connector 32.

In the present invention, when the housing and the cap are assembled via the connector, various/double types of the threads and shapes of the bottom portion of the housing can be selected. Thus, a better pressure resistance of the filter cartridge can be obtained, and the manufacturing cost thereof will not be increased. Additionally, most of users can conveniently observe the using condition of the filter media through the opened window formed on an outer circumference surface of the bottom portion of the housing and a transparent base in turn, so that the user then can decide whether the filter media should be changed or not. The filter cartridge of the present invention not only has the observable effect of a conventional transparent filter cartridge, but also it can overcome the problem that the pressure resistance of the conventional filter cartridge is not good enough.

The present invention been described with embodiments thereof, and it is understood that many changes and modifications to the described embodiments can be carried out without departing from the scope and the spirit of the invention that is intended to be limited only by the appended claims.

What is claimed is:

1. A filter cartridge having double threads, comprising:
a housing provided with a connecting portion, a filter containing portion and
a bottom portion;
a cap; and
a connector, wherein the cap is tightly connected to the housing by the connector; an outer circumference surface of the connector is provided with an outer connector thread, and an inner circumference surface of the connector is provided with an inner connector thread;
wherein the connecting portion of the housing has a first thread screw-connected to one of the outer connector thread and the inner connector thread of the connector; and
wherein the cap has a second thread screw-connected to the other of the outer connector thread and the inner connector thread of the connector.

2. The filter cartridge having double threads according to claim 1, wherein the diameter of the connecting portion is greater than the diameter of the filter containing portion, so that a junction between the connecting portion and the filter containing portion is formed with an inner step portion; and wherein an inner bottom of the connector is provided with a first ring installing groove, and a first O ring is installed in the first ring installing groove.

3. The filter cartridge having double threads according to claim 1, wherein the diameter of the connecting portion is smaller than the diameter of the filter containing portion, so that a junction between the connecting portion and the filter containing portion is formed with an outer step portion; and wherein a top of the connecting portion of the housing is provided with a second ring installing groove, and a second O ring is installed in the second ring installing groove.

4. The filter cartridge having double threads according to claim 1, wherein the filter cartridge further comprises a transparent base; the transparent base is installed inside the bottom portion of the housing; the transparent base is tightly matched with the inner bottom of the housing; and an outer circumference surface of the bottom portion of the housing is provided with at least one opened window.

5. The filter cartridge having double threads according to claim 4, wherein an outer circumference surface of an upper edge of the transparent base is provided with a fourth ring installing groove, and a fourth O ring is installed in the fourth ring installing groove.

6. The filter cartridge having double threads according to claim 1, wherein one or both of the inner connector thread and the outer connector thread are interrupted threads.

7. The filter cartridge having double threads according to claim 4, wherein one or both of the inner connector thread and the outer connector thread are interrupted threads.

8. The filter cartridge having double threads according to claim 1, wherein a center of the bottom portion of the housing is projected toward the connecting portion of the housing, so that the bottom portion is concave inward the housing.

9. The filter cartridge having double threads according to claim 4, wherein a center of the bottom portion of the housing is projected toward the connecting portion of the housing, so that the bottom portion is concave inward the housing.

10. The filter cartridge having double threads according to claim 6, wherein the outer connector thread is an interrupted rectangular thread, and the inner connector thread is an interrupted trapezoidal thread.
